(19) United States
(12) Patent Application Publication
(10) Pub. No.: US 2025/0267578 A1
(43) Pub. Date: Aug. 21, 2025

(54) SYSTEMS AND METHODS OF ADJUSTING MONITORING PERIODS

(71) Applicant: Meta Platforms Technologies, LLC, Menlo Park, CA (US)

(72) Inventors: Xiaodi Zhang, San Ramon, CA (US); Qi Qu, Redmond, WA (US); Ping Wang, Redmond, WA (US); Qing Zhao, Fremont, CA (US); Yee Sin Chan, San Francisco, CA (US); Achaleshwar Sahai, San Jose, CA (US)

(73) Assignee: Meta Platforms Technologies, LLC, Menlo Park, CA (US)

(21) Appl. No.: 19/023,067

(22) Filed: Jan. 15, 2025

Related U.S. Application Data
(60) Provisional application No. 63/554,198, filed on Feb. 16, 2024.

(51) Int. Cl. H04W 52/02; H04L 5/00; H04W 76/27

(52) U.S. Cl. CPC H04W 52/0225; H04W 76/27; H04L 5/0048

(57) ABSTRACT

Systems and methods for adjusting monitoring periods may include a wireless communication device which receives, from a wireless communication node, an information element comprising a timing offset and a frequency block. The wireless communication device may switch, from a radio resource control (RRC) connected mode to at least one of an RRC-idle mode or an RRC-inactive mode, subsequent to receiving the information element. The wireless communication device may perform a wake-up process at a time determined according to a cycle period, and the timing offset and the frequency block of the information element, to receive a tracking reference signal (TRS) message from the wireless communication node.

### CROSS-REFERENCE TO RELATED APPLICATIONS

This application claims the benefit of and priority to U.S. Provisional Application No. 63/554,198, filed Feb. 16, 2024, the contents of which are incorporated herein by reference in their entirety.

### FIELD OF DISCLOSURE

The present disclosure is generally related to wireless communication, including but not limited to, systems and methods of adjusting monitoring periods.

### BACKGROUND

Augmented reality (AR), virtual reality (VR), and mixed reality (MR) are becoming more prevalent, which such technology being supported across a wider variety of platforms and device. Some AR/VR/MR devices may communicate with one or more other remote devices via a cellular connection.

### SUMMARY

In one aspect, this disclosure relates to a method. The method may include receiving, by a wireless communication device from a wireless communication node, an information element including a timing offset and a frequency block. The method may include switching, by the wireless communication device, from a radio resource control (RRC) connected mode to at least one of an RRC-idle mode or an RRC-inactive mode, subsequent to receiving the information element. The method may include performing, by the wireless communication device, a wake-up process at a time determined according to a cycle period, and the timing offset and the frequency block of the information element, to receive a tracking reference signal (TRS) message from the wireless communication node.

In some embodiments, the wireless communication device receives the information element from the wireless communication node, responsive to the wireless communication node broadcasting the information element. In some embodiments, the information element broadcast by the wireless communication node includes a plurality of TRS identifiers, each TRS identifier associated with a corresponding timing offset and frequency block. In some embodiments, the method includes determining, by the wireless communication device, the timing offset and the frequency block in which to determine the time to perform the wake-up process, based on a TRS identifier of the plurality of TRS identifiers which is associated with the wireless communication device.

In some embodiments, the wireless communication device receives the information element in an RRC-release message. In some embodiments, the information element further includes a TRS identifier associated with the wireless communication device and the cycle period. In some embodiments, the method includes establishing, by the wireless communication device, an RRC connection with the wireless communication node. The method may further include synchronizing, by the wireless communication device, a clock of the wireless communication device with the wireless communication node. In some embodiments, the method includes determining, by the wireless communication device, the time in which to perform the wake-up process, based on the cycle period and the synchronized clock. In some embodiments, the wireless communication device switches to at least one of the RRC-idle mode or the RRC-inactive mode for at least one cycle corresponding to the cycle period, to forego monitoring of any synchronization signal blocks from the wireless communication node during the at least one cycle.

In another aspect, this disclosure is directed to a wireless communication device, including a transceiver and one or more processors configured to receive, via the transceiver from a wireless communication node, an information element including a timing offset and a frequency block. The one or more processors may be configured to switch, from a radio resource control (RRC) connected mode to at least one of an RRC-idle mode or an RRC-inactive mode, subsequent to receiving the information element. The one or more processors may be configured to perform a wake-up process at a time determined according to a cycle period, and the timing offset and the frequency block of the information element, to receive, via the transceiver, a tracking reference signal (TRS) message from the wireless communication node.

In some embodiments, the wireless communication device receives the information element from the wireless communication node, responsive to the wireless communication node broadcasting the information element. In some embodiments, the information element broadcast by the wireless communication node includes a plurality of TRS identifiers, each TRS identifier associated with a corresponding timing offset and frequency block. In some embodiments, the one or more processors are configured to determine the timing offset and the frequency block in which to determine the time to perform the wake-up process, based on a TRS identifier of the plurality of TRS identifiers which is associated with the wireless communication device.

In some embodiments, the information element is included in an RRC-release message. In some embodiments, the information element further includes a TRS identifier associated with the wireless communication device and the cycle period. In some embodiments, the one or more processors are configured to establish, via the transceiver, an RRC connection with the wireless communication node. The one or more processors may be configured to synchronize a clock of the wireless communication device with the wireless communication node. In some embodiments, the one or more processors are configured to determine the time in which to perform the wake-up process, based on the cycle period and the synchronized clock. In some embodiments, the one or more processors are configured to switch to at least one of the RRC-idle mode or the RRC-inactive mode for at least one cycle corresponding to the cycle period, to forego monitoring of any synchronization signal blocks from the wireless communication node during the at least one cycle.

In yet another aspect, this disclosure is directed to non-transitory computer readable medium storing instructions that, when executed by one or more processors, cause the one or more processors to receive, via a transceiver from a wireless communication node, an information element including a timing offset and a frequency block. The instructions may further cause the one or more processors to switch, from a radio resource control (RRC) connected mode to at least one of an RRC-idle mode or an RRC-inactive mode, subsequent to receiving the information element. The instructions may further cause the one or more processors to perform a wake-up process at a time determined according to a cycle period, and the timing offset and the frequency block of the information element, to receive, via the transceiver, a tracking reference signal (TRS) message from the wireless communication node.

In some embodiments, the information element is received via at least one of a broadcast message from the wireless communication node or an RRC-release message sent by the wireless communication node to the wireless communication device.

### BRIEF DESCRIPTION OF THE DRAWINGS

The accompanying drawings are not intended to be drawn to scale. Like reference numbers and designations in the various drawings indicate like elements. For purposes of clarity, not every component can be labeled in every drawing.

FIG. 1 is a diagram of an example wireless communication system, according to an example implementation of the present disclosure.

FIG. 2 is a diagram of a console and a head wearable display for presenting augmented reality or virtual reality, according to an example implementation of the present disclosure.

FIG. 3 is a diagram of a head wearable display, according to an example implementation of the present disclosure.

FIG. 4 is a block diagram of a computing environment according to an example implementation of the present disclosure.

FIG. 5 is a wake-up schedule for a user equipment (UE).

FIG. 6 is a block diagram of a system for adjusting a monitoring period, according to an example implementation of the present disclosure.

FIG. 7 is a process flow showing signaling between a wireless communication device and wireless communication node for adjusting a monitoring period, according to an example implementation of the present disclosure.

FIG. 8 is a wake-up schedule for the wireless communication device of FIG. 7, according to an example implementation of the present disclosure.

FIG. 9 is a flowchart showing an example method for adjusting a monitoring period, according to an example implementation of the present disclosure.

### DETAILED DESCRIPTION

Before turning to the figures, which illustrate certain embodiments in detail, it should be understood that the present disclosure is not limited to the details or methodology set forth in the description or illustrated in the figures. It should also be understood that the terminology used herein is for the purpose of description only and should not be regarded as limiting.

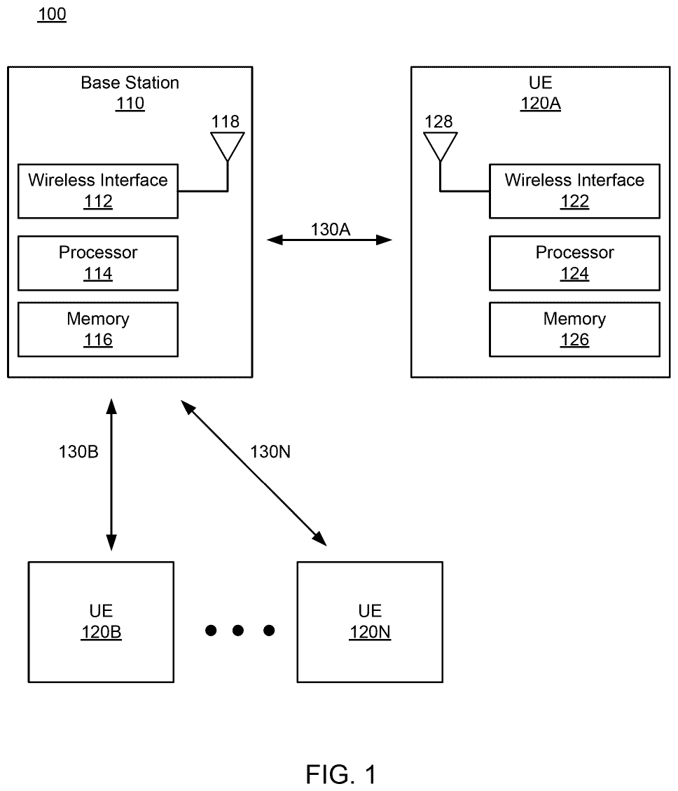

FIG. 1 illustrates an example wireless communication system 100. The wireless communication system 100 may include a base station 110 (also referred to as “a wireless communication node 110” or “a station 110”) and one or more user equipment (UEs) 120 (also referred to as “wireless communication devices 120” or “terminal devices 120”). The base station 110 and the UEs 120 may communicate through wireless commination links 130A, 130B, 130C. The wireless communication link 130 may be a cellular communication link conforming to 3G, 4G, 5G or other cellular communication protocols or a Wi-Fi communication protocol. In one example, the wireless communication link 130 supports, employs or is based on an orthogonal frequency division multiple access (OFDMA). In one aspect, the UEs 120 are located within a geographical boundary with respect to the base station 110, and may communicate with or through the base station 110. In some embodiments, the wireless communication system 100 includes more, fewer, or different components than shown in FIG. 1. For example, the wireless communication system 100 may include one or more additional base stations 110 than shown in FIG. 1.

In some embodiments, the UE 120 may be a user device such as a mobile phone, a smart phone, a personal digital assistant (PDA), tablet, laptop computer, wearable computing device, etc. Each UE 120 may communicate with the base station 110 through a corresponding communication link 130. For example, the UE 120 may transmit data to a base station 110 through a wireless communication link 130, and receive data from the base station 110 through the wireless communication link 130. Example data may include audio data, image data, text, etc. Communication or transmission of data by the UE 120 to the base station 110 may be referred to as an uplink communication. Communication or reception of data by the UE 120 from the base station 110 may be referred to as a downlink communication. In some embodiments, the UE 120A includes a wireless interface 122, a processor 124, a memory device 126, and one or more antennas 128. These components may be embodied as hardware, software, firmware, or a combination thereof. In some embodiments, the UE 120A includes more, fewer, or different components than shown in FIG. 1. For example, the UE 120 may include an electronic display and/or an input device. For example, the UE 120 may include additional antennas 128 and wireless interfaces 122 than shown in FIG. 1.

The antenna 128 may be a component that receives a radio frequency (RF) signal and/or transmit a RF signal through a wireless medium. The RF signal may be at a frequency between 200 MHz to 100 GHz. The RF signal may have packets, symbols, or frames corresponding to data for communication. The antenna 128 may be a dipole antenna, a patch antenna, a ring antenna, or any suitable antenna for wireless communication. In one aspect, a single antenna 128 is utilized for both transmitting the RF signal and receiving the RF signal. In one aspect, different antennas 128 are utilized for transmitting the RF signal and receiving the RF signal. In one aspect, multiple antennas 128 are utilized to support multiple-in, multiple-out (MIMO) communication.

The wireless interface 122 includes or is embodied as a transceiver for transmitting and receiving RF signals through a wireless medium. The wireless interface 122 may communicate with a wireless interface 112 of the base station 110 through a wireless communication link 130A. In one configuration, the wireless interface 122 is coupled to one or more antennas 128. In one aspect, the wireless interface 122 may receive the RF signal at the RF frequency received through antenna 128, and downconvert the RF signal to a baseband frequency (e.g., 0˜1 GHz). The wireless interface 122 may provide the downconverted signal to the processor 124. In one aspect, the wireless interface 122 may receive a baseband signal for transmission at a baseband frequency from the processor 124, and upconvert the baseband signal to generate a RF signal. The wireless interface 122 may transmit the RF signal through the antenna 128.

The processor 124 is a component that processes data. The processor 124 may be embodied as field programmable gate array (FPGA), application specific integrated circuit (ASIC), a logic circuit, etc. The processor 124 may obtain instructions from the memory device 126, and executes the instructions. In one aspect, the processor 124 may receive downconverted data at the baseband frequency from the wireless interface 122, and decode or process the downconverted data. For example, the processor 124 may generate audio data or image data according to the downconverted data, and present an audio indicated by the audio data and/or an image indicated by the image data to a user of the UE 120A. In one aspect, the processor 124 may generate or obtain data for transmission at the baseband frequency, and encode or process the data. For example, the processor 124 may encode or process image data or audio data at the baseband frequency, and provide the encoded or processed data to the wireless interface 122 for transmission.

The memory device 126 is a component that stores data. The memory device 126 may be embodied as random access memory (RAM), flash memory, read only memory (ROM), erasable programmable read-only memory (EPROM), electrically erasable programmable read-only memory (EEPROM), registers, a hard disk, a removable disk, a CD-ROM, or any device capable for storing data. The memory device 126 may be embodied as a non-transitory computer readable medium storing instructions executable by the processor 124 to perform various functions of the UE 120A disclosed herein. In some embodiments, the memory device 126 and the processor 124 are integrated as a single component.

In some embodiments, each of the UEs 120B . . . 120N includes similar components of the UE 120A to communicate with the base station 110. Thus, detailed description of duplicated portion thereof is omitted herein for the sake of brevity.

In some embodiments, the base station 110 may be an evolved node B (eNB), a serving eNB, a target eNB, a femto station, or a pico station. The base station 110 may be communicatively coupled to another base station 110 or other communication devices through a wireless communication link and/or a wired communication link. The base station 110 may receive data (or a RF signal) in an uplink communication from a UE 120. Additionally or alternatively, the base station 110 may provide data to another UE 120, another base station, or another communication device. Hence, the base station 110 allows communication among UEs 120 associated with the base station 110, or other UEs associated with different base stations. In some embodiments, the base station 110 includes a wireless interface 112, a processor 114, a memory device 116, and one or more antennas 118. These components may be embodied as hardware, software, firmware, or a combination thereof. In some embodiments, the base station 110 includes more, fewer, or different components than shown in FIG. 1. For example, the base station 110 may include an electronic display and/or an input device. For example, the base station 110 may include additional antennas 118 and wireless interfaces 112 than shown in FIG. 1.

The antenna 118 may be a component that receives a radio frequency (RF) signal and/or transmit a RF signal through a wireless medium. The antenna 118 may be a dipole antenna, a patch antenna, a ring antenna, or any suitable antenna for wireless communication. In one aspect, a single antenna 118 is utilized for both transmitting the RF signal and receiving the RF signal. In one aspect, different antennas 118 are utilized for transmitting the RF signal and receiving the RF signal. In one aspect, multiple antennas 118 are utilized to support multiple-in, multiple-out (MIMO) communication.

The wireless interface 112 includes or is embodied as a transceiver for transmitting and receiving RF signals through a wireless medium. The wireless interface 112 may communicate with a wireless interface 122 of the UE 120 through a wireless communication link 130. In one configuration, the wireless interface 112 is coupled to one or more antennas 118. In one aspect, the wireless interface 112 may receive the RF signal at the RF frequency received through antenna 118, and downconvert the RF signal to a baseband frequency (e.g., 0˜1 GHz). The wireless interface 112 may provide the downconverted signal to the processor 124. In one aspect, the wireless interface 122 may receive a baseband signal for transmission at a baseband frequency from the processor 114, and upconvert the baseband signal to generate a RF signal. The wireless interface 112 may transmit the RF signal through the antenna 118.

The processor 114 is a component that processes data. The processor 114 may be embodied as FPGA, ASIC, a logic circuit, etc. The processor 114 may obtain instructions from the memory device 116, and executes the instructions. In one aspect, the processor 114 may receive downconverted data at the baseband frequency from the wireless interface 112, and decode or process the downconverted data. For example, the processor 114 may generate audio data or image data according to the downconverted data. In one aspect, the processor 114 may generate or obtain data for transmission at the baseband frequency, and encode or process the data. For example, the processor 114 may encode or process image data or audio data at the baseband frequency, and provide the encoded or processed data to the wireless interface 112 for transmission. In one aspect, the processor 114 may set, assign, schedule, or allocate communication resources for different UEs 120. For example, the processor 114 may set different modulation schemes, time slots, channels, frequency bands, etc. for UEs 120 to avoid interference. The processor 114 may generate data (or UL CGs) indicating configuration of communication resources, and provide the data (or UL CGs) to the wireless interface 112 for transmission to the UEs 120.

The memory device 116 is a component that stores data. The memory device 116 may be embodied as RAM, flash memory, ROM, EPROM, EEPROM, registers, a hard disk, a removable disk, a CD-ROM, or any device capable for storing data. The memory device 116 may be embodied as a non-transitory computer readable medium storing instructions executable by the processor 114 to perform various functions of the base station 110 disclosed herein. In some embodiments, the memory device 116 and the processor 114 are integrated as a single component.

In some embodiments, communication between the base station 110 and the UE 120 is based on one or more layers of Open Systems Interconnection (OSI) model. The OSI model may include layers including: a physical layer, a Medium Access Control (MAC) layer, a Radio Link Control (RLC) layer, a Packet Data Convergence Protocol (PDCP) layer, a Radio Resource Control (RRC) layer, a Non Access Stratum (NAS) layer or an Internet Protocol (IP) layer, and other layer.

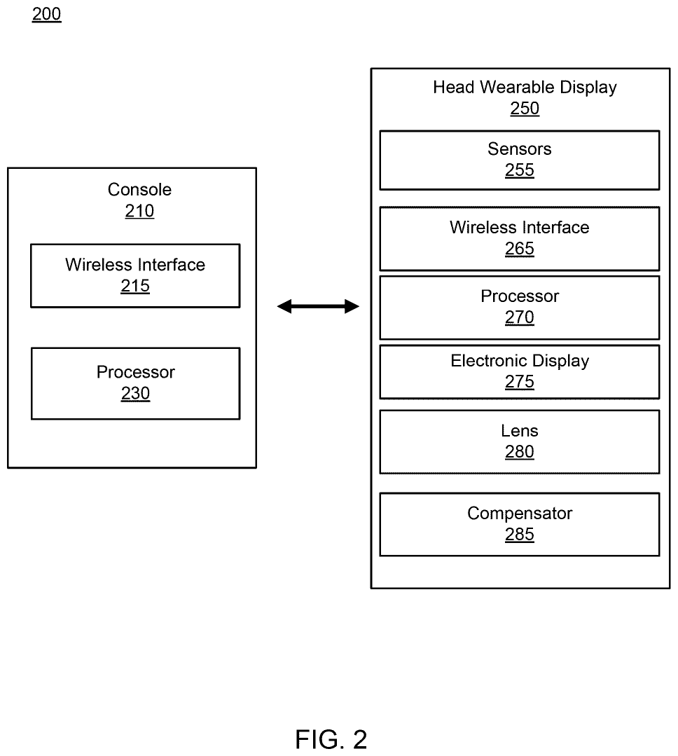

FIG. 2 is a block diagram of an example artificial reality system environment 200. In some embodiments, the artificial reality system environment 200 includes a HWD 250 worn by a user, and a console 210 providing content of artificial reality (e.g., augmented reality, virtual reality, mixed reality) to the HWD 250. Each of the HWD 250 and the console 210 may be a separate UE 120. The HWD 250 may be referred to as, include, or be part of a head mounted display (HMD), head mounted device (HMD), head wearable device (HWD), head worn display (HWD) or head worn device (HWD). The HWD 250 may detect its location and/or orientation of the HWD 250 as well as a shape, location, and/or an orientation of the body/hand/face of the user, and provide the detected location/or orientation of the HWD 250 and/or tracking information indicating the shape, location, and/or orientation of the body/hand/face to the console 210. The console 210 may generate image data indicating an image of the artificial reality according to the detected location and/or orientation of the HWD 250, the detected shape, location and/or orientation of the body/hand/face of the user, and/or a user input for the artificial reality, and transmit the image data to the HWD 250 for presentation. In some embodiments, the artificial reality system environment 200 includes more, fewer, or different components than shown in FIG. 2. In some embodiments, functionality of one or more components of the artificial reality system environment 200 can be distributed among the components in a different manner than is described here. For example, some of the functionality of the console 210 may be performed by the HWD 250. For example, some of the functionality of the HWD 250 may be performed by the console 210. In some embodiments, the console 210 is integrated as part of the HWD 250.

In some embodiments, the HWD 250 is an electronic component that can be worn by a user and can present or provide an artificial reality experience to the user. The HWD 250 may render one or more images, video, audio, or some combination thereof to provide the artificial reality experience to the user. In some embodiments, audio is presented via an external device (e.g., speakers and/or headphones) that receives audio information from the HWD 250, the console 210, or both, and presents audio based on the audio information. In some embodiments, the HWD 250 includes sensors 255, a wireless interface 265, a processor 270, an electronic display 275, a lens 280, and a compensator 285. These components may operate together to detect a location of the HWD 250 and a gaze direction of the user wearing the HWD 250, and render an image of a view within the artificial reality corresponding to the detected location and/or orientation of the HWD 250. In other embodiments, the HWD 250 includes more, fewer, or different components than shown in FIG. 2.

In some embodiments, the sensors 255 include electronic components or a combination of electronic components and software components that detect a location and an orientation of the HWD 250. Examples of the sensors 255 can include: one or more imaging sensors, one or more accelerometers, one or more gyroscopes, one or more magnetometers, or another suitable type of sensor that detects motion and/or location. For example, one or more accelerometers can measure translational movement (e.g., forward/back, up/down, left/right) and one or more gyroscopes can measure rotational movement (e.g., pitch, yaw, roll). In some embodiments, the sensors 255 detect the translational movement and the rotational movement, and determine an orientation and location of the HWD 250. In one aspect, the sensors 255 can detect the translational movement and the rotational movement with respect to a previous orientation and location of the HWD 250, and determine a new orientation and/or location of the HWD 250 by accumulating or integrating the detected translational movement and/or the rotational movement. Assuming for an example that the HWD 250 is oriented in a direction 25 degrees from a reference direction, in response to detecting that the HWD 250 has rotated 20 degrees, the sensors 255 may determine that the HWD 250 now faces or is oriented in a direction 45 degrees from the reference direction. Assuming for another example that the HWD 250 was located two feet away from a reference point in a first direction, in response to detecting that the HWD 250 has moved three feet in a second direction, the sensors 255 may determine that the HWD 250 is now located at a vector multiplication of the two feet in the first direction and the three feet in the second direction.

In some embodiments, the sensors 255 include eye trackers. The eye trackers may include electronic components or a combination of electronic components and software components that determine a gaze direction of the user of the HWD 250. In some embodiments, the HWD 250, the console 210 or a combination of them may incorporate the gaze direction of the user of the HWD 250 to generate image data for artificial reality. In some embodiments, the eye trackers include two eye trackers, where each eye tracker captures an image of a corresponding eye and determines a gaze direction of the eye. In one example, the eye tracker determines an angular rotation of the eye, a translation of the eye, a change in the torsion of the eye, and/or a change in shape of the eye, according to the captured image of the eye, and determines the relative gaze direction with respect to the HWD 250, according to the determined angular rotation, translation and the change in the torsion of the eye. In one approach, the eye tracker may shine or project a predetermined reference or structured pattern on a portion of the eye, and capture an image of the eye to analyze the pattern projected on the portion of the eye to determine a relative gaze direction of the eye with respect to the HWD 250. In some embodiments, the eye trackers incorporate the orientation of the HWD 250 and the relative gaze direction with respect to the HWD 250 to determine a gate direction of the user. Assuming for an example that the HWD 250 is oriented at a direction 30 degrees from a reference direction, and the relative gaze direction of the HWD 250 is −10 degrees (or 350 degrees) with respect to the HWD 250, the eye trackers may determine that the gaze direction of the user is 20 degrees from the reference direction. In some embodiments, a user of the HWD 250 can configure the HWD 250 (e.g., via user settings) to enable or disable the eye trackers. In some embodiments, a user of the HWD 250 is prompted to enable or disable the eye trackers.

In some embodiments, the wireless interface 265 includes an electronic component or a combination of an electronic component and a software component that communicates with the console 210. The wireless interface 265 may be or correspond to the wireless interface 122. The wireless interface 265 may communicate with a wireless interface 215 of the console 210 through a wireless communication link through the base station 110. Through the communication link, the wireless interface 265 may transmit to the console 210 data indicating the determined location and/or orientation of the HWD 250, and/or the determined gaze direction of the user. Moreover, through the communication link, the wireless interface 265 may receive from the console 210 image data indicating or corresponding to an image to be rendered and additional data associated with the image.

In some embodiments, the processor 270 includes an electronic component or a combination of an electronic component and a software component that generates one or more images for display, for example, according to a change in view of the space of the artificial reality. In some embodiments, the processor 270 is implemented as a part of the processor 124 or is communicatively coupled to the processor 124. In some embodiments, the processor 270 is implemented as a processor (or a graphical processing unit (GPU)) that executes instructions to perform various functions described herein. The processor 270 may receive, through the wireless interface 265, image data describing an image of artificial reality to be rendered and additional data associated with the image, and render the image to display through the electronic display 275. In some embodiments, the image data from the console 210 may be encoded, and the processor 270 may decode the image data to render the image. In some embodiments, the processor 270 receives, from the console 210 in additional data, object information indicating virtual objects in the artificial reality space and depth information indicating depth (or distances from the HWD 250) of the virtual objects. In one aspect, according to the image of the artificial reality, object information, depth information from the console 210, and/or updated sensor measurements from the sensors 255, the processor 270 may perform shading, reprojection, and/or blending to update the image of the artificial reality to correspond to the updated location and/or orientation of the HWD 250. Assuming that a user rotated his head after the initial sensor measurements, rather than recreating the entire image responsive to the updated sensor measurements, the processor 270 may generate a small portion (e.g., 10%) of an image corresponding to an updated view within the artificial reality according to the updated sensor measurements, and append the portion to the image in the image data from the console 210 through reprojection. The processor 270 may perform shading and/or blending on the appended edges. Hence, without recreating the image of the artificial reality according to the updated sensor measurements, the processor 270 can generate the image of the artificial reality.

In some embodiments, the electronic display 275 is an electronic component that displays an image. The electronic display 275 may, for example, be a liquid crystal display or an organic light emitting diode display. The electronic display 275 may be a transparent display that allows the user to see through. In some embodiments, when the HWD 250 is worn by a user, the electronic display 275 is located proximate (e.g., less than 3 inches) to the user's eyes. In one aspect, the electronic display 275 emits or projects light towards the user's eyes according to image generated by the processor 270.

In some embodiments, the lens 280 is a mechanical component that alters received light from the electronic display 275. The lens 280 may magnify the light from the electronic display 275, and correct for optical error associated with the light. The lens 280 may be a Fresnel lens, a convex lens, a concave lens, a filter, or any suitable optical component that alters the light from the electronic display 275. Through the lens 280, light from the electronic display 275 can reach the pupils, such that the user can see the image displayed by the electronic display 275, despite the close proximity of the electronic display 275 to the eyes.

In some embodiments, the compensator 285 includes an electronic component or a combination of an electronic component and a software component that performs compensation to compensate for any distortions or aberrations. In one aspect, the lens 280 introduces optical aberrations such as a chromatic aberration, a pin-cushion distortion, barrel distortion, etc. The compensator 285 may determine a compensation (e.g., predistortion) to apply to the image to be rendered from the processor 270 to compensate for the distortions caused by the lens 280, and apply the determined compensation to the image from the processor 270. The compensator 285 may provide the predistorted image to the electronic display 275.

In some embodiments, the console 210 is an electronic component or a combination of an electronic component and a software component that provides content to be rendered to the HWD 250. In one aspect, the console 210 includes a wireless interface 215 and a processor 230. These components may operate together to determine a view (e.g., a FOV of the user) of the artificial reality corresponding to the location of the HWD 250 and the gaze direction of the user of the HWD 250, and can generate image data indicating an image of the artificial reality corresponding to the determined view. In addition, these components may operate together to generate additional data associated with the image. Additional data may be information associated with presenting or rendering the artificial reality other than the image of the artificial reality. Examples of additional data include, hand model data, mapping information for translating a location and an orientation of the HWD 250 in a physical space into a virtual space (or simultaneous localization and mapping (SLAM) data), eye tracking data, motion vector information, depth information, edge information, object information, etc. The console 210 may provide the image data and the additional data to the HWD 250 for presentation of the artificial reality. In other embodiments, the console 210 includes more, fewer, or different components than shown in FIG. 2. In some embodiments, the console 210 is integrated as part of the HWD 250.

In some embodiments, the wireless interface 215 is an electronic component or a combination of an electronic component and a software component that communicates with the HWD 250. The wireless interface 215 may be or correspond to the wireless interface 122. The wireless interface 215 may be a counterpart component to the wireless interface 265 to communicate through a communication link (e.g., wireless communication link). Through the communication link, the wireless interface 215 may receive from the HWD 250 data indicating the determined location and/or orientation of the HWD 250, and/or the determined gaze direction of the user. Moreover, through the communication link, the wireless interface 215 may transmit to the HWD 250 image data describing an image to be rendered and additional data associated with the image of the artificial reality.

The processor 230 can include or correspond to a component that generates content to be rendered according to the location and/or orientation of the HWD 250. In some embodiments, the processor 230 is implemented as a part of the processor 124 or is communicatively coupled to the processor 124. In some embodiments, the processor 230 may incorporate the gaze direction of the user of the HWD 250. In one aspect, the processor 230 determines a view of the artificial reality according to the location and/or orientation of the HWD 250. For example, the processor 230 maps the location of the HWD 250 in a physical space to a location within an artificial reality space, and determines a view of the artificial reality space along a direction corresponding to the mapped orientation from the mapped location in the artificial reality space. The processor 230 may generate image data describing an image of the determined view of the artificial reality space, and transmit the image data to the HWD 250 through the wireless interface 215. In some embodiments, the processor 230 may generate additional data including motion vector information, depth information, edge information, object information, hand model data, etc., associated with the image, and transmit the additional data together with the image data to the HWD 250 through the wireless interface 215. The processor 230 may encode the image data describing the image, and can transmit the encoded data to the HWD 250. In some embodiments, the processor 230 generates and provides the image data to the HWD 250 periodically (e.g., every 11 ms).

In one aspect, the process of detecting the location of the HWD 250 and the gaze direction of the user wearing the HWD 250, and rendering the image to the user should be performed within a frame time (e.g., 11 ms or 16 ms). A latency between a movement of the user wearing the HWD 250 and an image displayed corresponding to the user movement can cause judder, which may result in motion sickness and can degrade the user experience. In one aspect, the HWD 250 and the console 210 can prioritize communication for AR/VR, such that the latency between the movement of the user wearing the HWD 250 and the image displayed corresponding to the user movement can be presented within the frame time (e.g., 11 ms or 16 ms) to provide a seamless experience.

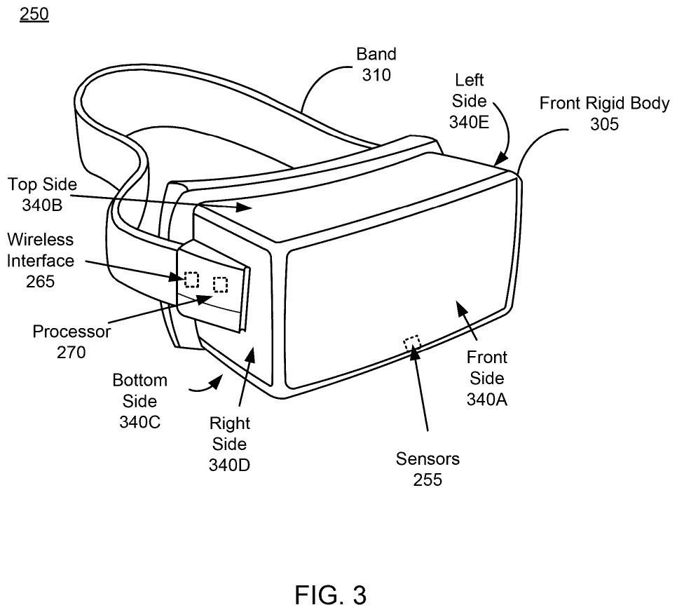

FIG. 3 is a diagram of a HWD 250, in accordance with an example embodiment. In some embodiments, the HWD 250 includes a front rigid body 305 and a band 310. The front rigid body 305 includes the electronic display 275 (not shown in FIG. 3), the lens 280 (not shown in FIG. 3), the sensors 255, the wireless interface 265, and the processor 270. In the embodiment shown by FIG. 3, the wireless interface 265, the processor 270, and the sensors 255 are located within the front rigid body 205, and may not be visible externally. In other embodiments, the HWD 250 has a different configuration than shown in FIG. 3. For example, the wireless interface 265, the processor 270, and/or the sensors 255 may be in different locations than shown in FIG. 3.

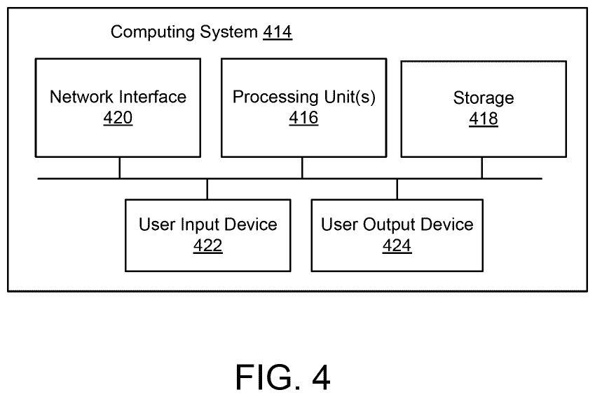

Various operations described herein can be implemented on computer systems. FIG. 4 shows a block diagram of a representative computing system 414 usable to implement the present disclosure. In some embodiments, the source devices 110, the sink device 120, the console 210, the HWD 250 are implemented by the computing system 414. Computing system 414 can be implemented, for example, as a consumer device such as a smartphone, other mobile phone, tablet computer, wearable computing device (e.g., smart watch, eyeglasses, head wearable display), desktop computer, laptop computer, or implemented with distributed computing devices. The computing system 414 can be implemented to provide VR, AR, MR experience. In some embodiments, the computing system 414 can include conventional computer components such as processors 416, storage device 418, network interface 420, user input device 422, and user output device 424.

Network interface 420 can provide a connection to a wide area network (e.g., the Internet) to which WAN interface of a remote server system is also connected. Network interface 420 can include a wired interface (e.g., Ethernet) and/or a wireless interface implementing various RF data communication standards such as Wi-Fi, Bluetooth, or cellular data network standards (e.g., 3G, 4G, 5G, 60 GHz, LTE, etc.).

The network interface 420 may include a transceiver to allow the computing system 414 to transmit and receive data from a remote device using a transmitter and receiver. The transceiver may be configured to support transmission/reception supporting industry standards that enables bi-directional communication. An antenna may be attached to transceiver housing and electrically coupled to the transceiver. Additionally or alternatively, a multi-antenna array may be electrically coupled to the transceiver such that a plurality of beams pointing in distinct directions may facilitate in transmitting and/or receiving data.

A transmitter may be configured to wirelessly transmit frames, slots, or symbols generated by the processor unit 416. Similarly, a receiver may be configured to receive frames, slots or symbols and the processor unit 416 may be configured to process the frames. For example, the processor unit 416 can be configured to determine a type of frame and to process the frame and/or fields of the frame accordingly.

User input device 422 can include any device (or devices) via which a user can provide signals to computing system 414; computing system 414 can interpret the signals as indicative of particular user requests or information. User input device 422 can include any or all of a keyboard, touch pad, touch screen, mouse or other pointing device, scroll wheel, click wheel, dial, button, switch, keypad, microphone, sensors (e.g., a motion sensor, an eye tracking sensor, etc.), and so on.

User output device 424 can include any device via which computing system 414 can provide information to a user. For example, user output device 424 can include a display to display images generated by or delivered to computing system 414. The display can incorporate various image generation technologies, e.g., a liquid crystal display (LCD), light-emitting diode (LED) including organic light-emitting diodes (OLED), projection system, cathode ray tube (CRT), or the like, together with supporting electronics (e.g., digital-to-analog or analog-to-digital converters, signal processors, or the like). A device such as a touchscreen that function as both input and output device can be used. Output devices 424 can be provided in addition to or instead of a display. Examples include indicator lights, speakers, tactile “display” devices, printers, and so on.

Some implementations include electronic components, such as microprocessors, storage and memory that store computer program instructions in a computer readable storage medium (e.g., non-transitory computer readable medium). Many of the features described in this specification can be implemented as processes that are specified as a set of program instructions encoded on a computer readable storage medium. When these program instructions are executed by one or more processors, they cause the processors to perform various operation indicated in the program instructions. Examples of program instructions or computer code include machine code, such as is produced by a compiler, and files including higher-level code that are executed by a computer, an electronic component, or a microprocessor using an interpreter. Through suitable programming, processor 416 can provide various functionality for computing system 414, including any of the functionality described herein as being performed by a server or client, or other functionality associated with message management services.

It will be appreciated that computing system 414 is illustrative and that variations and modifications are possible. Computer systems used in connection with the present disclosure can have other capabilities not specifically described here. Further, while computing system 414 is described with reference to particular blocks, it is to be understood that these blocks are defined for convenience of description and are not intended to imply a particular physical arrangement of component parts. For instance, different blocks can be located in the same facility, in the same server rack, or on the same motherboard. Further, the blocks need not correspond to physically distinct components. Blocks can be configured to perform various operations, e.g., by programming a processor or providing appropriate control circuitry, and various blocks might or might not be reconfigurable depending on how the initial configuration is obtained. Implementations of the present disclosure can be realized in a variety of apparatus including electronic devices implemented using any combination of circuitry and software.

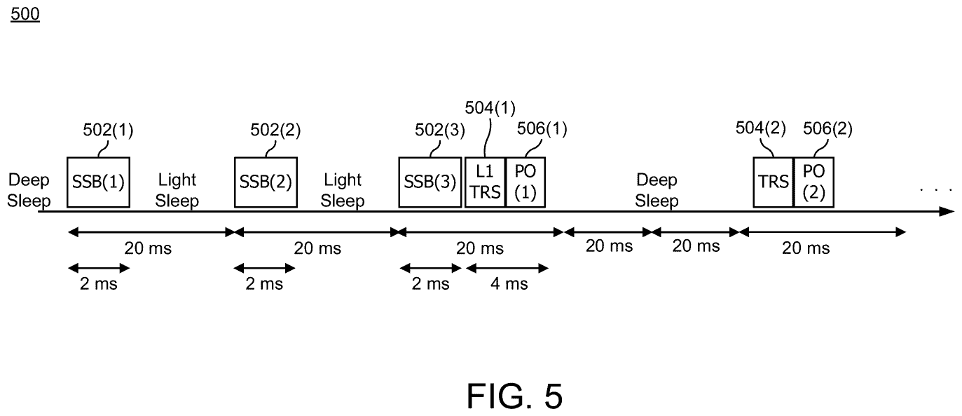

Referring generally to FIG. 5, depicted is a wake-up schedule 500 for a user equipment (UE). In new radio (NR) idle/inactive mode, and as shown in FIG. 5, one source of user equipment (UE) power consumption can be to wake up intermittently to decode synchronization signal blocks (SSBs) 502 for time and frequency synchronization, and to prepare for paging occasion (PO) 506 decoding in an automatic gain control (AGC) update. In NR idle/inactive mode, a UE may monitor SSBs 502, instead of monitoring a tracking reference signal (TRS) resource 504 for PO reception, which may be available after receiving downlink control information (DCI) that activates the TRS 504 for tracking purposes. As shown in FIG. 5, the UE may enter a deep sleep (e.g., at a first time instance), and subsequently intermittently wake up to decode SSBs 502(1)-502(3). Such intermittent wake-up procedures may only permit a light sleep mode (e.g., a sleep mode of a duration of the SSB period, such as 20 ms, less the duration in which the SSB is received and decoded, such as 2 ms). This may unnecessarily cause increased power consumption, since the TRS and PO are only received after the third SSB 502(3) in the example shown in FIG. 5, which may be configured in separate DCI signaling.

According to the systems and methods described herein, the present solution addresses the above identified problems by utilizing a valid TRS/channel status information reference signal (CSI-RS) set for a time and frequency. When a UE is switched to radio resource control (RRC) idle or inactive mode from RRC connected mode, a gNB can indicate to the UE which TRS resource set to use for TRS monitoring, and indicate a validation duration or timer in a RRC release message. In another scenario, a gNB may broadcast a default TRS resource set to use in a system information block (SIB) (e.g., SIB-17) to multiple UEs. In addition to indicating the TRS resources for a specific cell (e.g., to one or more UEs in the specific cell), the above solutions can apply to radio access network (RAN)-based notification area (RNA) as well (e.g., to one or more UEs in an RNA encompassing more than one cell). Within a RNA, the indication of the TRS resource set via RRC release message(s) or the SIB-17 message(s) can be coordinated among multiple cells/base stations.

For example, and as described in greater detail below, the UE may be configured to receive an information element (e.g., in an RRC release message, in a broadcast message, an RNA message, etc.) which indicates a timing offset and frequency block. The UE may switch (e.g., from an RRC connected mode) to an RRC idle/inactive mode subsequent to receiving the information element. The UE can then perform a wake-up process according to a cycle period, and the timing offset and frequency block of the information element, to receive the TRS message from the wireless communication node. The systems and methods for enhancing the use of reference signals for tracking purposes as described herein may reduce UE power consumption and prolong device battery life. For example, the UE can enter a deep sleep mode to forego receipt and decoding of SSBs 502, until the UE is scheduled to receive a TRS 504 and correspondingly PO 506, thereby avoiding the light sleep mode which results from intermittent wake-up procedures to receive and decode the SSBs 502.

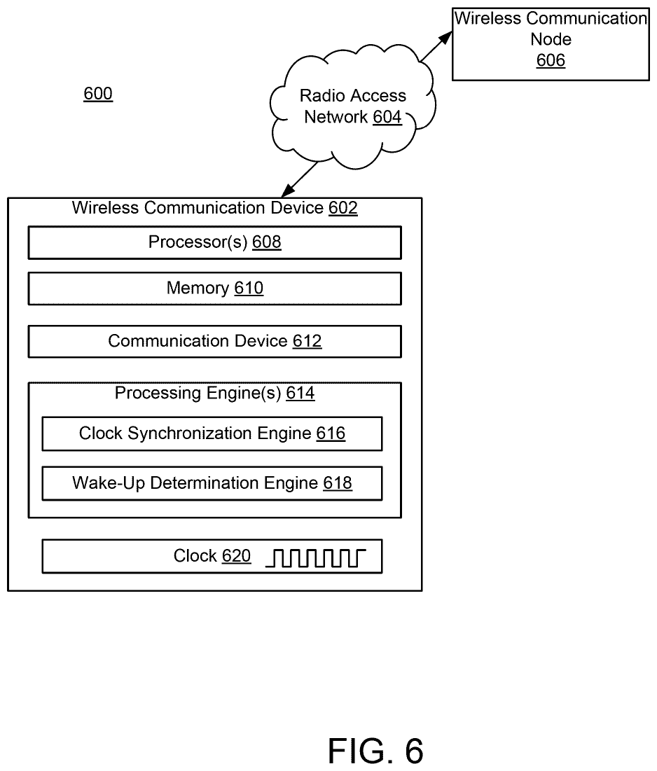

Referring now to FIG. 6, depicted is a block diagram of a system 600 for adjusting a monitoring period, according to an example implementation of the present disclosure. The system 600 may include a wireless communication device 602 communicably coupled via a radio access network 604 to a wireless communication node 606. The wireless communication device 602 may be similar to the user equipment 120, console 210, and/or head wearable display 250 described above with reference to FIG. 1-FIG. 4. In some embodiments, the wireless communication device 602 may be a power-constrained (e.g., reduced capability/reduced capacity) user equipment. The wireless communication node 606 may be, include, or be similar to the base station 110 described above with reference to FIG. 1.

The wireless communication device 602 may one or more processors 608, memory 610, and a communication device 612. While shown as included on the wireless communication device 602, in various embodiments, the wireless communication node 606 may similarly include processor(s), memory, and a communication device. The processor(s) 608 may be the same as or similar to the processors 114, 124, 230, 270 and/or processing unit(s) 416 described above with reference to FIG. 1-FIG. 4. The memory 610 may be the same as or similar to memory 116, 126, and/or storage 418 described above with reference to FIG. 1-FIG. 4. The communication device 612 may be the same as or similar to the wireless interface 112, 122, 215, 265 (e.g., in combination with or communicably coupled to antenna 118, 128) and/or network interface 420 described above with reference to FIG. 1-FIG. 4.

The wireless communication device 602 may include one or more processing engines 614. The processing engine(s) 614 may be or include any device, component, element, or hardware designed or configured to perform one or more of the functions described herein. The processing engine(s) 614 may include a clock synchronization engine 616 and a wake-up determination engine 618. While these processing engine(s) 614 are shown and described herein, it should be understood that additional and/or alternative processing engine(s) 614 may be implemented on the wireless communication device 602. Additionally, two or more of the processing engine(s) 614 may be implemented as a single processing engine 614. Furthermore, one of the processing engine(s) 614 may implemented as multiple processing engines 614. While the processing engine(s) 614 are shown as generally included on the wireless communication device 602, it should be understood that the processing engine(s) 614 may be included/incorporated/executed/deployed at any layer of the device 602, including at a physical layer of the device 602 (e.g., by the communication device 612) or at any higher layer of the device 602 (e.g., at the medium access control (MAC) layer, radio link control (RLC) layer, packet data convergence protocol (PDCP) layer, service data adaptation protocol (SDAP) layer, the internet protocol (IP)/network layer, and/or application layer).

The wireless communication device 602 may include a clock 620. The clock 620 may be or include a clock signal (e.g., from an oscillator) of the wireless communication device 602, used as a hardware timing reference. The clock synchronization engine 616 may be configured to manage, configure, or otherwise synchronize the clock signal with a corresponding synchronization signal received from the wireless communication node 606. For example, when the wireless communication device 602 establishes a connection (e.g., a radio resource control (RRC) connection) with the wireless communication node 606, the wireless communication node 606 may be configured to transmit a synchronization signal or system information block (SIB) including timing information to the wireless communication device 602. The clock synchronization engine 616 may be configured to synchronize the clock signal of the clock 620, according to the timing information/synchronization signal from the wireless communication node 606. For example, the clock synchronization engine 616 may be configured to synchronize the clock signal of the clock 620, by generating a secondary clock signal which is aligned with the received synchronization signal/timing information.

In various instances, following establishing an RRC connection with the wireless communication node 606, the wireless communication device 602 may switch from an RRC-connected mode to an RRC-idle or RRC-inactive mode. In the RRC-idle mode, the wireless communication device 602 may not maintain an active signaling connection with the wireless communication node 606 but may periodically monitor paging occasions (POs) and system information blocks (SIBs) for incoming messages or updates. Similarly, in the RRC-inactive mode, the wireless communication device 602 may maintain a lightweight signaling context, such as the radio access network (RAN)-based notification area (RNA), to reduce latency for re- (re-)establishing a connection while still minimizing power consumption by foregoing continuous monitoring of control channels. The wireless communication device 602 may switch from the RRC-connected mode to the RRC-idle/RRC-inactive mode, to reduce power consumption when active communication with the wireless communication node 606 is not needed by the wireless communication device 602. For instance, after completing data transmission or reception, the wireless communication device 602 can switch to the RRC-idle/inactive modes to conserve battery life while still remaining reachable for POs or for reestablishing an RRC connection (e.g., switching to an RRC-connected mode). Additionally, switching to RRC-idle or RRC-inactive mode can help optimize network resource utilization by frecing up signaling resources of the radio access network 604, or signaling resources of the wireless communication node 606, when the wireless communication device 602 is not actively engaged in data exchange with the wireless communication node 606.

As described in greater detail below, the wireless communication device 602 may be configured to receive an information element from the wireless communication node 606, where the information element includes information relating to a time in which the wireless communication device 602 is to wake-up from an RRC-idle/inactive mode for receipt of a TRS 504. The wireless communication device 602 may be configured to enter the RRC-idle/inactive mode, and later perform a wake-up procedure according to the information included in the information clement received from the wireless communication node 606.

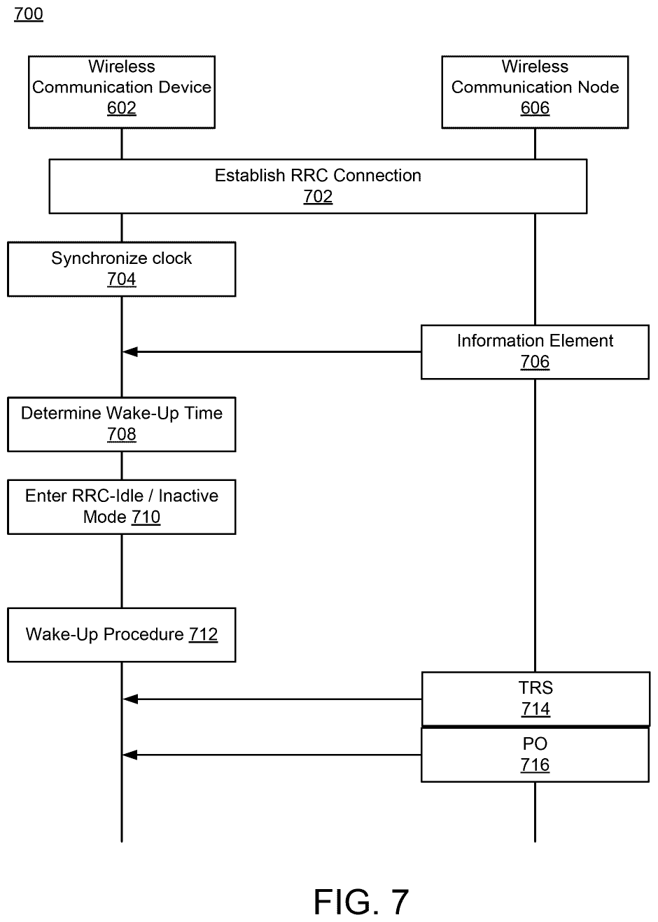

Referring now to FIG. 7, depicted is a process flow 700 showing signaling between the wireless communication device and wireless communication node for adjusting a monitoring period, according to an example implementation of the present disclosure.

At process 702, the wireless communication device 602 and wireless communication node 606 may be configured to establish an RRC connection. The wireless communication device 602 may initiate an RRC connection, responsive to determining to perform various network-related tasks such as data transmission, reception of critical signaling information, or initial network registration. For example, the wireless communication device 602 may be configured to initiate the RRC connection responsive to launching an application which is to use or leverage uplink or downlink data services. To establish the RRC connection, the wireless communication device may be configured to transmit an RRC connection request to the wireless communication node 606, with the wireless communication node 606 responding with an RRC connection setup message. The wireless communication device 602 and wireless communication node 606 may establish the RRC connection, responsive to an acknowledgement or reply from the wireless communication device 602 of the RRC connection setup message (e.g., with an RRC connection setup complete message).

At process 704, the clock synchronization engine 616 may be configured to synchronize a clock of the wireless communication device 602 with synchronization information exchanged as part of the RRC connection (e.g., at connection set-up or subsequent synchronization information). To synchronize the clock 620 of the wireless communication device 602 with synchronization information from the wireless communication node 606, the wireless communication device 602 may be configured to establish a secondary clock signal using information from a synchronization signal or system information block (SIB) from the wireless communication node 606 (e.g., such that the secondary clock signal is synchronized with the synchronization information from the wireless communication node 606).

At process 706, the wireless communication node 606 may be configured to communicate, send, broadcast, transmit, or otherwise provide an information element to the wireless communication device 602. The information element may include a timing offset and a frequency block, which may indicate or otherwise identify the specific time and frequency resources for receiving a TRS. The timing offset may define a relative time delay from a reference point (e.g., a system frame number or a start of a paging cycle). The frequency block may indicate or otherwise identify the frequency resources allocated for the TRS.

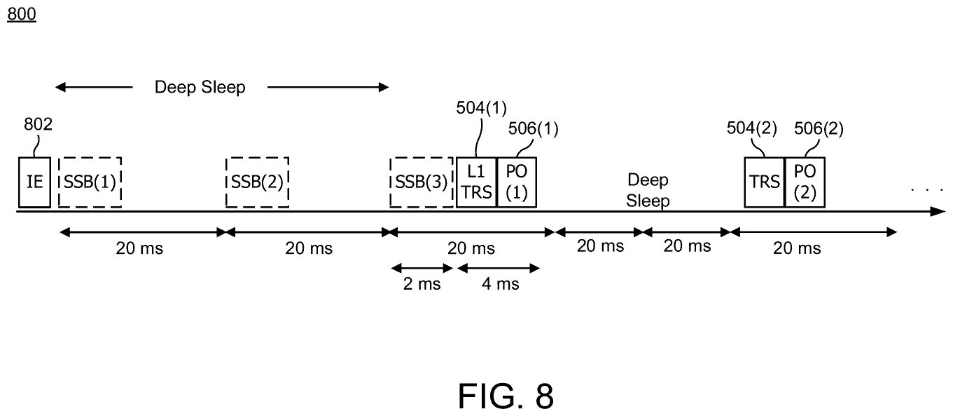

In some embodiments, the information element may further include a cycle period and TRS identifier. The cycle period may identify, define, or otherwise configure a period/periodicity in which a signaling cycle from the wireless communication node is to repeat. In some embodiments, the cycle period may be predefined, fixed, or configured by the wireless communication node. In the example shown in FIG. 5 described above and FIG. 8 described below, the cycle period may be 20 milliseconds, though other cycle periods may be used, configured, or otherwise provided by the wireless communication node 606. In some embodiments, the cycle period may be predefined or a default cycle period. In such instances, the information element may include any changes, delta, or deviation from the predefined or default cycle period. For example, where the predefined/default cycle period is 20 ms, and the wireless communication node 606 determines to use a different cycle period (e.g., of 30 ms), the wireless communication node 606 may generate the information element to indicate the different cycle period (e.g., to indicate a 30 ms cycle period). In some embodiments, the cycle period may may signaled from a plurality of cycle periods, by corresponding bits in the information element (e.g., “00” for 10 ms, “01” for 20 ms, “10” for 30 ms, and “11” for 40 ms). While these examples are provided, the present disclosure contemplates various other examples or implementations for signaling the cycle period or periodicity of the scheduling cycle for the wireless communication node 606.

The TRS identifier may identify specific TRS resources (e.g., timing offsets, frequency blocks, and/or cycle periods) for groups, sets, or subsets of wireless communication devices 602 using, assigned to, or otherwise linked to the TRS identifier. For example, and as described in greater detail below, an information element may include multiple TRS identifiers which configure, specify, or otherwise indicate respective frequency blocks, timing offsets, and/or cycle period(s) to be used by the respective wireless communication devices associated with the TRS identifiers.

As described in greater detail below, the timing offset, frequency block, and cycle period may be used by the wireless communication device 602 to schedule wake-up times accurately and avoid unnecessary monitoring of synchronization signal blocks (SSBs), thereby reducing power consumption.

In some embodiments, the wireless communication node 606 may be configured to provide the information element in an RRC-release message. The wireless communication node 606 may be configured to transmit the information element in the RRC-release message, responsive to determining to transition the wireless communication device 602 from the RRC-connected state to an RRC-idle or RRC-inactive state. For example, the wireless communication node 606 may be configured to determine to transition the wireless communication device 602 to the RRC-idle or RRC-inactive state, after completing data transfer to the wireless communication device 602 (e.g., such that no further data is needed to be transmitted to the wireless communication device 602), or otherwise determining that maintaining the RRC connection is no longer needed for the wireless communication device 602.

In some embodiments, the wireless communication node 606 may be configured to provide the information element in a broadcast message. The broadcast message may be periodically broadcast by the wireless communication node 606 to wireless communication devices 602 in a service area of the wireless communication node 606. The broadcast message may be, for example, a system information block (e.g., an SIB-17), or some other periodic broadcast message. The broadcast message may include or provide configuration information to multiple UEs within a cell. For example, the broadcast message may include parameters such as default TRS resources, timing offsets, and frequency blocks applicable to wireless communication devices 602 in the cell or RNA (or wireless communication devices 602 associated with respective TRS identifiers (TRS IDs)). In some embodiments, the wireless communication node 606 may be configured to provide the information element in a RNA message. Like the broadcast message, the RNA message may be configured to provide a notification to wireless communication devices 602 operating within a RAN-based notification area (RNA), and may include information similar to that provided in the broadcast message.

In some embodiments, the information element may include a TRS identifier. The TRS identifier may be or include a unique identifier associated with a specific TRS resource within the radio access network 604. The TRS identifier may facilitate the wireless communication device 602 in differentiating between multiple TRS resources that may be available within a cell or a RNA. In some embodiments, each TRS ID may be associated with corresponding timing offsets and frequency blocks. The number of TRS IDs included in an information element may depend on the manner in which the information element is provided by the wireless communication node 606 to the wireless communication device 602. For example, when the information element is included in an RRC-release message, the TRS ID may specifically indicate the TRS resource dedicated to the transitioning wireless communication device 602. In broadcast messages or RNA messages, the TRS ID may indicate a default TRS resource shared among multiple wireless communication devices 602 within a cell or RNA. Additionally, a broadcast/RNA message may include multiple TRS IDs, where each TRS ID is associated with TRS resources which are to be shared amongst respective wireless communication devices 602 which are associated with the TRS ID.

At process 708, the wake-up determination engine 618 may be configured to determine a wake-up time (e.g., a time in which to initiate or perform a wake-up process or procedure). The wake-up determination engine 618 may be configured to determine the wake-up time based on the information included in the information element provided at process 706. For example, the wake-up determination engine 618 may calculate the wake-up time using the timing offset indicated in the information element, which specifies a relative delay from a reference time (e.g., a system frame number or paging cycle). The wake-up determination engine 618 may also use the cycle period associated with the TRS resource (e.g., 20 ms as a default cycle period, for instance, or some other cycle period indicated in the information element or otherwise provided by the wireless communication node 606 to the wireless communication device 602). In some embodiments, the wake-up determination engine 618 may be configured to use the frequency block information from the information element, to determine which frequency resources are to be monitored at the scheduled wake-up time.

Where the information clement includes a plurality of TRS IDs, the wake-up determination engine 618 may be configured to determine the wake-up time based on the TRS ID which is associated with the wireless communication device 602. For example, the wake-up determination engine 618 may identify the TRS ID corresponding to the wireless communication device 602 from the plurality of TRS IDs included in the information element. Each TRS ID may be associated with specific timing offsets and frequency blocks. The wake-up determination engine 618 may be configured to use the timing offset and frequency block linked to the TRS ID which corresponds to the wireless communication device 602, to determine the wake-up time for the wireless communication device 602.

At process 710, the wireless communication device 602 may enter an RRC-idle or RRC-inactive mode. The wireless communication device 602 may enter the RRC-idle/inactive mode, to forego receipt of various SSBs which may be broadcast by the wireless communication node 606 while the wireless communication device 602 is in a sleep mode (e.g., according to the RRC-idle/inactive mode). The wireless communication device 602 may enter the sleep mode (e.g., a deep sleep mode), until the determined wake-up time (e.g., determined at process 708).

At process 712, the wireless communication device 602 may initiate, commence, or otherwise perform a wake-up procedure. The wireless communication device 602 may be configured to perform the wake-up procedure by activating the communication device 612 to listen for signals received (e.g., for the cycle period) on the frequency block indicated in the information element. The wireless communication device may perform the wake-up procedure, to identify receive a TRS (transmitted or otherwise provided) at process 714, and a corresponding paging occasion (PO) (transmitted or otherwise provided) at process 716. Following receipt of the TRS and PO, the wireless communication device 602 may be configured to re-enter an RRC-idle or inactive mode, until a subsequent wake-up procedure is initiated.

Referring now to FIG. 8, depicted is a wake-up schedule 800 for the wireless communication device 602, according to an example implementation of the present disclosure. As shown in FIG. 8, the wake-up schedule 800 may be similar to the wake-up schedule 500 described above. However, in FIG. 8, because the wireless communication device 602 receives the information element 802 (e.g., prior to entering the RRC-inactive/idle mode), the wake-up determination engine 618 may configured to determine the time in which to perform the wake-up procedure, thereby facilitating the wireless communication device to enter into a deep sleep (thereby avoiding receipt of the first through third SSBs 502(1)-502(3) of FIG. 5). Rather, the wireless communication device 602 may perform the wake-up procedure at a start of, e.g., the third cycle period to receive the first TRS 504(1) and PO 506(1).

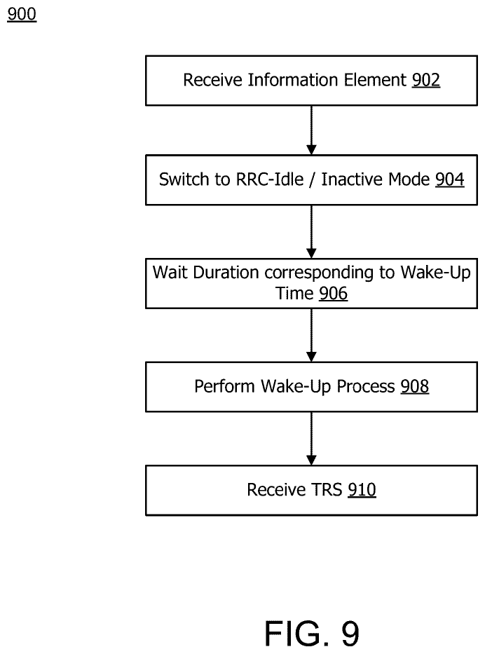

Referring now to FIG. 9, depicted is a flowchart showing an example method 900 for adjusting a monitoring period, according to an example implementation of the present disclosure. The method 900 may be performed, executed, or otherwise provided on the devices, components, elements, or hardware described above with reference to FIG. 1-FIG. 8, such as the wireless communication device. As a brief overview, at step 902, a wireless communication device receives an information element. At step 904, the wireless communication device switches to an RRC-Idle or RRC-inactive mode. At step 906, the wireless communication device may wait a duration corresponding to the wake-up time. At step 908, the wireless communication device may perform a wake-up process. At step 910, the wireless communication device may receive a tracking reference signal (TRS).

At step 902, a wireless communication device receives an information element. In some embodiments, the wireless communication device may receive the information element from a wireless communication device. The wireless communication device may receive the information element, responsive to the wireless communication node broadcasting, transmitting, or otherwise providing the information element (e.g., in one or more signaling) to the wireless communication device. The wireless communication device may receive the information element, following establishing a radio resource control (RRC) connection with the wireless communication node. For example, and in some embodiments, prior to step 902, the method may include establishing the RRC connection with the wireless communication node (e.g., to facilitate transmission or receipt of data between the wireless communication device and wireless communication node).

In some embodiments, as part of establishing the RRC connection, or following establishing the RRC connection, the wireless communication device may synchronize a clock of the wireless communication device with the wireless communication node. For example, the wireless communication device may receive synchronization information (e.g., a synchronization signal or system information block (SIB)) from the wireless communication node. The wireless communication device may synchronize a clock of the wireless communication device, according to the synchronization information. For example, the wireless communication device may establish or otherwise configure a secondary clock signal using, based on, or according to the synchronization information, such that the secondary clock signal is synchronized with a clock of the wireless communication node. As described in greater detail below, the wireless communication device may use the synchronized clock, along with other information in the information element, to determine a wake-up time in which to perform a wake-up process.

In some embodiments, the information element may include, at least, a timing offset and a frequency block. The timing offset may indicate or otherwise identify an offset from a reference point (e.g., a system frame number or paging cycle) from which to perform the wake-up process in which to monitor for signaling from the wireless communication node. The frequency block may indicate or otherwise identify frequency resources in which the wireless communication device is to use for monitoring the signaling from the wireless communication node.

In some embodiments, the information element may further include a cycle period. The cycle period may be or include a duration in which a cycle or schedule (e.g., signaling schedule, such as a TRS cycle or schedule) from the wireless communication node is repeated. For example, and in the examples shown in FIG. 5 and FIG. 8, the cycle period may be 20 milliseconds (which may be a default cycle period), though any cycle period may be used or signaled in the information element. In some implementations, the information element may include the cycle period where the cycle period is different than a default cycle period. For instance, where the cycle period used by the wireless communication node is the default cycle period, the wireless communication node may forego providing the cycle period in the information element (or may signal to the wireless communication device is to use the default cycle period). Where they cycle period used by the wireless communication node is different than the default cycle period, the wireless communication node may signal the different cycle period (e.g., in the information clement or in some other signaling). In some embodiments, the information element may include a tracking reference signal (TRS) identifier (TRS ID). The TRS ID may be associated with corresponding timing offsets and frequency resources which correspond to wireless communication devices. For example, where the information element includes multiple TRS IDs, the wireless communication device may determine which timing offset and frequency resource to use for determining a wake-up time, using a TRS ID which is linked to, assigned to, or otherwise associated with the wireless communication device.

In some embodiments, the wireless communication node may broadcast the information clement to wireless communication devices in a service area or RNA of the wireless communication node. In such embodiments, the wireless communication device may receive the information element from the wireless communication node, responsive to the wireless communication node broadcasting the information element. For example, the wireless communication node may periodically broadcast the information element (e.g., in a system information block, or SIB-17). The wireless communication device may receive the information clement responsive to the wireless communication node periodically broadcasting the information element. In some embodiments, the information element may include one or more TRS-IDs. For example, a broadcast information element may include a plurality of TRS-IDs, where each TRS-ID is associated with a respective or corresponding timing offset and frequency block. Such implementations may allow the wireless communication node to configure multiple timing offsets, frequency blocks, and/or cycle periods which are to be shared amongst a subset of wireless communication device(s) in the service area/RNA of the wireless communication node.

In some embodiments, the wireless communication device may receive the information clement in an RRC-release message. For example, the wireless communication node may transmit the RRC-release message to the wireless communication device, responsive to determining to no longer maintain an active RRC-connection (e.g., responsive to transmitting all downlink data to the wireless communication device, as one example). In some embodiments, the RRC-release message (e.g., the information element of the RRC-release message) may include the TRS identifier associated with the wireless communication device. In this example, the information element (including the contents thereof, such as the timing offset, frequency block, and/or cycle period) may be specific to the wireless communication device.

At step 904, the wireless communication device switches to an RRC-idle or RRC-inactive mode. In some embodiments, the wireless communication device may switch from an RRC-connected mode to an RRC-idle or RRC-inactive mode. The wireless communication device may switch to the RRC-idle or-inactive mode, subsequent to receiving the information element (e.g., at step 902). In other words, the wireless communication device may receive the information clement while in an RRC-connected mode (or in connection with establishing an active RRC-connection), and switch to the RRC-inactive/RRC-idle mode following receipt of the information element (e.g., at a later time instance). The wireless communication device may switch to the RRC-idle or RRC-inactive mode for at least one cycle period (e.g., to enter a deep sleep mode). In switching to the RRC-inactive or RRC-idle mode, the wireless communication device may thereby forego monitoring of or receipt of any synchronization signal blocks from the wireless communication node during the cycle period.

At step 906, the wireless communication device may wait a duration corresponding to the wake-up time. In some embodiments, the wireless communication device may determine the duration, based on a time (or wake-up time) in which to perform the wake-up process. For example, the wireless communication device may determine the time in which to perform the wake-up process, by determining the timing offset relative to the reference point (e.g., paging occasion or synchronization signal) and using the synchronized clock of the wireless communication device. For example, the timing offset may indicate a number of cycle periods from a time in which the wireless communication device is to enter the RRC-inactive/RRC-idle mode. The wireless communication device may determine the time based on the number of cycle periods and the timing offset from the reference point, using the synchronized clock as a reference. For example, assuming the information element indicates a timing offset (e.g., of four ms) relative to a start of a third cycle of the cycle period, the wireless communication device may determine the wake-up time as three cycles (e.g., 60 ms, assuming a cycle period of 20 ms) and four ms, from a start of the first cycle after the wireless communication device switches to the RRC-idle/inactive mode (e.g., using the synchronized clock as a reference). The wireless communication device may wait a duration, until the time (e.g., the wake-up time).

At step 908, the wireless communication device may perform a wake-up process. In some embodiments, the wireless communication device may perform a wake-up process according to the cycle period, and the timing offset and the frequency block of the information element, to receive a tracking reference signal (TRS) message from the wireless communication node. The wireless communication device may perform the wake-up process to initiate a wake-up using the timing offset, and monitor frequency resources according to the frequency block. The wireless communication device may perform the wake-up process following waiting the duration at step 906. Following initiating the wake-up process, at step 910, the wireless communication device may receive a tracking reference signal (TRS). The wireless communication device may perform the wake-up process, to wake-up just in time to receive the TRS (e.g., on a channel corresponding to the frequency resources indicated by the frequency block and monitored by the wireless communication device). In some embodiments, the wireless communication device may receive a paging occasion (PO) subsequent to receiving the TRS. For example, the wireless communication device may use the TRS to perform time and frequency synchronization and automatic gain control (AGC) updating, to prepare the wireless communication device to receive and successfully decode the PO. In this regard, the wireless communication device may use the TRS to perform time and frequency synchronization instead of the SSBs, which the wireless communication device may not receive given its deep-sleep.

In some embodiments, the method 900 may loop back to step 906, following receipt of the TRS (and PO) from the wireless communication node. In this regard, the wireless communication node may iteratively wait the duration, without having to wake-up to receive and decode synchronization signal blocks from the wireless communication node (which may not pertain to the wireless communication device).

Having now described some illustrative implementations, it is apparent that the foregoing is illustrative and not limiting, having been presented by way of example. In particular, although many of the examples presented herein involve specific combinations of method acts or system elements, those acts and those elements can be combined in other ways to accomplish the same objectives. Acts, elements and features discussed in connection with one implementation are not intended to be excluded from a similar role in other implementations or implementations.

The hardware and data processing components used to implement the various processes, operations, illustrative logics, logical blocks, modules and circuits described in connection with the embodiments disclosed herein may be implemented or performed with a general purpose single-or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device, etc.) may include one or more devices (e.g., RAM, ROM, Flash memory, hard disk storage, etc.) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit and/or the processor) the one or more processes described herein.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular can also embrace implementations including a plurality of these elements, and any references in plural to any implementation or element or act herein can also embrace implementations including only a single element. References in the singular or plural form are not intended to limit the presently disclosed systems or methods, their components, acts, or elements to single or plural configurations. References to any act or element being based on any information, act or element can include implementations where the act or element is based at least in part on any information, act, or element.

Any implementation disclosed herein can be combined with any other implementation or embodiment, and references to “an implementation,” “some implementations,” “one implementation” or the like are not necessarily mutually exclusive and are intended to indicate that a particular feature, structure, or characteristic described in connection with the implementation can be included in at least one implementation or embodiment. Such terms as used herein are not necessarily all referring to the same implementation. Any implementation can be combined with any other implementation, inclusively or exclusively, in any manner consistent with the aspects and implementations disclosed herein.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Systems and methods described herein may be embodied in other specific forms without departing from the characteristics thereof. References to “approximately,” “about” “substantially” or other terms of degree include variations of +/−10% from the given measurement, unit, or range unless explicitly indicated otherwise. Coupled elements can be electrically, mechanically, or physically coupled with one another directly or with intervening elements. Scope of the systems and methods described herein is thus indicated by the appended claims, rather than the foregoing description, and changes that come within the meaning and range of equivalency of the claims are embraced therein.

The term “coupled” and variations thereof includes the joining of two members directly or indirectly to one another. Such joining may be stationary (e.g., permanent or fixed) or moveable (e.g., removable or releasable). Such joining may be achieved with the two members coupled directly with or to each other, with the two members coupled with each other using a separate intervening member and any additional intermediate members coupled with one another, or with the two members coupled with each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References to “or” can be construed as inclusive so that any terms described using “or” can indicate any of a single, more than one, and all of the described terms. A reference to “at least one of ‘A’ and ‘B’” can include only ‘A’, only ‘B’, as well as both ‘A’ and ‘B’. Such references used in conjunction with “comprising” or other open terminology can include additional items.

Modifications of described elements and acts such as variations in sizes, dimensions, structures, shapes and proportions of the various elements, values of parameters, mounting arrangements, use of materials, colors, orientations can occur without materially departing from the teachings and advantages of the subject matter disclosed herein. For example, elements shown as integrally formed can be constructed of multiple parts or elements, the position of elements can be reversed or otherwise varied, and the nature or number of discrete elements or positions can be altered or varied. Other substitutions, modifications, changes and omissions can also be made in the design, operating conditions and arrangement of the disclosed elements and operations without departing from the scope of the present disclosure.

References herein to the positions of elements (e.g., “top,” “bottom,” “above,” “below”) are merely used to describe the orientation of various elements in the FIGURES. The orientation of various elements may differ according to other exemplary embodiments, and that such variations are intended to be encompassed by the present disclosure.

What is claimed is:

1. A method, comprising:
receiving, by a wireless communication device from a wireless communication node, an information element comprising a timing offset and a frequency block;
switching, by the wireless communication device, from a radio resource control (RRC) connected mode to at least one of an RRC-idle mode or an RRC-inactive mode, subsequent to receiving the information element; and
performing, by the wireless communication device, a wake-up process at a time determined according to a cycle period, and the timing offset and the frequency block of the information element, to receive a tracking reference signal (TRS) message from the wireless communication node.

2. The method of claim 1, wherein the wireless communication device receives the information element from the wireless communication node, responsive to the wireless communication node broadcasting the information element.

3. The method of claim 2, wherein the information element broadcast by the wireless communication node includes a plurality of TRS identifiers, each TRS identifier associated with a corresponding timing offset and frequency block.

4. The method of claim 3, further comprising:
determining, by the wireless communication device, the timing offset and the frequency block in which to determine the time to perform the wake-up process, based on a TRS identifier of the plurality of TRS identifiers which is associated with the wireless communication device.

5. The method of claim 1, wherein the wireless communication device receives the information element in an RRC-release message.

6. The method of claim 1, wherein the information element further comprises a TRS identifier associated with the wireless communication device and the cycle period.

7. The method of claim 1, further comprising:
establishing, by the wireless communication device, an RRC connection with the wireless communication node; and
synchronizing, by the wireless communication device, a clock of the wireless communication device with the wireless communication node.

8. The method of claim 7, further comprising:
determining, by the wireless communication device, the time in which to perform the wake-up process, based on the cycle period and the synchronized clock.

9. The method of claim 1, wherein the wireless communication device switches to at least one of the RRC-idle mode or the RRC-inactive mode for at least one cycle corresponding to the cycle period, to forego monitoring of any synchronization signal blocks from the wireless communication node during the at least one cycle.

10. A wireless communication device, comprising:
a transceiver; and
one or more processors configured to:
receive, via the transceiver from a wireless communication node, an information element comprising a timing offset and a frequency block;
switch, from a radio resource control (RRC) connected mode to at least one of an RRC-idle mode or an RRC-inactive mode, subsequent to receiving the information element; and
perform a wake-up process at a time determined according to a cycle period, and the timing offset and the frequency block of the information element, to receive, via the transceiver, a tracking reference signal (TRS) message from the wireless communication node.

11. The wireless communication device of claim 10, wherein the wireless communication device receives the information element from the wireless communication node, responsive to the wireless communication node broadcasting the information element.

12. The wireless communication device of claim 11, wherein the information element broadcast by the wireless communication node includes a plurality of TRS identifiers, each TRS identifier associated with a corresponding timing offset and frequency block.

13. The wireless communication device of claim 12, wherein the one or more processors are configured to:
determine the timing offset and the frequency block in which to determine the time to perform the wake-up process, based on a TRS identifier of the plurality of TRS identifiers which is associated with the wireless communication device.

14. The wireless communication device of claim 10, wherein the information element is included in an RRC-release message.

15. The wireless communication device of claim 10, wherein the information element further comprises a TRS identifier associated with the wireless communication device and the cycle period.

16. The wireless communication device of claim 10, wherein the one or more processors are configured to:
establish, via the transceiver, an RRC connection with the wireless communication node; and
synchronize a clock of the wireless communication device with the wireless communication node.

17. The wireless communication device of claim 16, wherein the one or more processors are configured to:
determine the time in which to perform the wake-up process, based on the cycle period and the synchronized clock.

18. The wireless communication device of claim 10, wherein the one or more processors are configured to switch to at least one of the RRC-idle mode or the RRC-inactive mode for at least one cycle corresponding to the cycle period, to forego monitoring of any synchronization signal blocks from the wireless communication node during the at least one cycle.

19. A non-transitory computer readable medium storing instructions that, when executed by one or more processors, cause the one or more processors to:
receive, via a transceiver from a wireless communication node, an information element comprising a timing offset and a frequency block;
switch, from a radio resource control (RRC) connected mode to at least one of an RRC-idle mode or an RRC-inactive mode, subsequent to receiving the information element; and
perform a wake-up process at a time determined according to a cycle period, and the timing offset and the frequency block of the information element, to receive, via the transceiver, a tracking reference signal (TRS) message from the wireless communication node.

20. The non-transitory computer readable medium of claim 19, wherein the information element is received via at least one of a broadcast message from the wireless communication node or an RRC-release message sent by the wireless communication node.
